(19) United States
(12) Patent Application Publication
(10) Pub. No.: US 2008/0090542 A1
(43) Pub. Date: Apr. 17, 2008

(54) METHOD FOR INTERFERENCE-FREE FREQUENCY CHANGE IN A RECEIVING SYSTEM WITH A PLURALITY OF PARALLEL OPERATED RECEVERS

(76) Inventors: Andreas Leistner, Ottobrunn (DE); Carsten Huber, Gemmrighelm (DE)

Correspondence Address: MG-IP Law, PLLC, P.O. BOX 1364, FAIRFAX, VA, 22038-1364, US

(21) Appl. No.: 11/869,743

(22) Filed: Oct. 9, 2007

Related U.S. Application Data
(63) Continuation of application No. PCT/EP2006/002994, filed on Apr. 1, 2006.

(30) Foreign Application Priority Data
Apr. 7, 2005 (DE) DE 102005017005

(51) Int. Cl. H04B 15/00

(52) U.S. Cl. 455/313

(57) ABSTRACT

A method is presented for changing a frequency of a first local oscillator in a receiving system, which has a first receiver with the first local oscillator and a first frequency control element and a second receiver with a second local oscillator and a second frequency control element. The method is characterized in that the following steps are performed during a change in a frequency of the first local oscillator from an actual frequency of the first local oscillator to a target frequency, at which an actual frequency of the second local oscillator lies between the actual frequency of the first local oscillator and the target frequency: turning off the first local oscillator, control of the first frequency control element such that the first frequency control element provides a first base value, assigned to the target frequency, of a frequency control variable, turning on the first local oscillator, and setting of the frequency of the first local oscillator to the target frequency. Furthermore, a receiving system is presented.

This nonprovisional application is a continuation of International Application No. PCT/EP2006/002994, which was filed on Apr. 1, 2006, and which claims priority to German Patent Application No. DE 102005017005, which was filed in Germany on Apr. 7, 2005, and which are both herein incorporated by reference.

### BACKGROUND OF THE INVENTION

1. Field of the Invention

The present invention relates to a method for changing a frequency of a first local oscillator in a receiving system, which has a first receiver with the first local oscillator and a first frequency control element and a second receiver with a second local oscillator and a second frequency control element.

The invention also relates to a receiving system, which has a first receiver with a first local oscillator and a first frequency control element, at least one second receiver with a second local oscillator and a second frequency control element, and a frequency control device, which controls and/or regulates a change in a frequency of the first local oscillator from an actual frequency of the first local oscillator to a target frequency, whereby an actual frequency of the second local oscillator lies between the actual frequency of the first local oscillator and the target frequency. Further, the invention also relates to a computer program and a storage medium of a frequency control device of the receiving system.

2. Description of the Background Art

In the conventional art, for example, a plurality of receivers operating in parallel are used in the mobile reception of radio signals, as in modern automobile radios. The so-called Radio Data System (RDS) transmits information on which alternative frequencies the same radio program can be received in the particular case. The receiver can then check the different alternative frequencies for their receive quality and select the best frequency for playback. In so doing, it is of advantage to allow a background receiver, which checks the alternative frequencies for the receive quality, to run in the background in addition to an audio receiver. If a background receiver of this type indicates an alternative frequency with a better receive quality, the audio receiver, for example, is switched to this frequency.

A background receiver of this type can be regarded, for example, as the first receiver and the audio receiver as the second receiver. Basically, during parallel operation, occurring in close proximity, of two or more receivers each with its own local oscillator, an interfering interaction between the two receivers can occur when two local oscillators oscillate at similar frequencies. In the case of the first receiver operating as the background receiver, it routinely occurs that the first local oscillator builds up to alternative frequencies and during a change between two alternative frequencies oscillates briefly in the vicinity of the frequency of the second local oscillator or passes through its frequency. Without countermeasures, interferences than occur because of the indicated interactions.

It is understood that the roles of the first and second receivers are exchangeable in regard to unwanted interactions. Thus, for example, the building up of the audio receiver to a new receive frequency can interfere with the reception of the background receiver and vice versa.

In conventional superheterodyne receivers, a high-frequency receive signal is down-mixed by superposition of oscillator signals to an intermediate frequency. It is problematic in this case that local oscillators of the different receivers must be decoupled very greatly from one another to avoid mutual interactions. A known corrective measure provides for a separation of the frequency ranges of the local oscillators by the use of different sidebands during mixing to the intermediate frequency of the superheterodyne receiver. This is not always possible, however, depending on the width of the employed band and the position of the intermediate frequency. In some applications, the use of one sideband is favored, because during use of the other sideband the image frequency can occur, e.g., in frequency ranges in which strong interference radiation must be anticipated.

### SUMMARY OF THE INVENTION

It is therefore an object of the present invention to provide a method and a receiving system with which the interfering interactions during operation, occurring parallel in time, of a plurality of receivers each with its own local oscillators can be reduced.

This object is attained in a method of the aforementioned type by performing the following steps during a change in a frequency of the first local oscillator from an actual frequency of the first local oscillator to a target frequency, at which an actual frequency of the second local oscillator lies between the actual frequency of the first local oscillator and the target frequency: turning off the first local oscillator, control of the first frequency control element such that the first frequency control element provides a first base value, assigned to the target frequency, of a frequency control variable, turning on the first local oscillator, and setting of the frequency of the first local oscillator to the target frequency.

Furthermore, this object is attained by a receiving system of the aforementioned type in that the frequency control device turns the first local oscillator off, controls the first frequency control element such that the first frequency control element provides a first base value, assigned to the target frequency, of a frequency control variable, and turns on the first local oscillator, and in that the first receiver sets the frequency of the first local oscillator to the target frequency.

Furthermore, this object is obtained by a computer program, which is programmed for use in the method, and by a storage medium of a frequency control device of the receiving system, in which a computer program for use in the method is stored.

By means of this procedure, the first local oscillator is turned off at the time when the functionally coupled first frequency control element sets its control signal to the first base value. The entire time course of the control signal change therefore is not reproduced in the signal of the first local oscillator. Instead, only the signals of the first frequency control element are reproduced in the signal of the first local oscillator in the first approximation before and after the change. In this way, interferences resulting from the aforementioned interactions are avoided. As a result, this leads to the desired interference-free frequency change.

In regard to the embodiments of the invention, the first base value can be predefined such that after the turning on of the first local oscillator it leads to a first fundamental frequency, which is above the frequency of the second local oscillator, when the target frequency is above the second local oscillator, or which alternatively is below the frequency of the second local oscillator, when the target frequency is below the frequency of the second local oscillator.

The first base value can be predefined such that after the turning on of the first local oscillator, it leads to a first fundamental frequency that is further removed from the actual frequency of the second local oscillator than the target frequency.

This embodiment takes into account that overshoots in the time course of the frequency of the first local oscillator can occur during the subsequent setting to the target frequency. By means of the initially larger frequency distance, it is for the most part avoided that the frequency of the first local oscillator during an overshoot undesirably approaches the frequency of the second local oscillator. In other words, the first base value to a certain extent provides for a safety margin that is greater than the expected overshoot.

The setting step can have a successively occurring presetting of at least one additional base value, which leads to another fundamental frequency, closer to the target frequency than the first fundamental frequency.

The risk of interactions, resulting from overshoots, between the local oscillators is further reduced by this embodiment.

In the described method for changing the oscillation frequency of an oscillator, additional frequency ranges susceptible to interference (e.g., the receive frequencies of additional receivers), apart from the receive frequency of the local oscillators, in additional receivers can also be taken into account in a similar way in selecting fundamental frequencies used for changing the oscillation frequency.

It is therefore preferred that in a receiving system with additional receivers, each of which has a local oscillator and a frequency control element, the first base value is predefined such that it leads to a fundamental frequency that is above the actual frequencies of all local oscillators, which are smaller than the target frequency, and that is below the actual frequencies of all local oscillators, which are greater than the target frequency.

By means of these features, the aforementioned advantages also take effect in receiving systems with a total of n parallel operated receivers, n being greater than 2.

According to an embodiment, values, assigned to the target frequency, the actual frequency of the first local oscillator, and the actual frequency of the second local oscillator, are stored, whereby the first frequency control element depending on the stored values is controlled such that it provides the first base value depending on the stored values. In this way, differences in the tuning behavior of the local oscillators due to different frequency/control voltage characteristics advantageously do not have an impact.

Furthermore, stored values can be used to check whether the actual frequency of the second local oscillator lies between the actual frequency of the first local oscillator and the target frequency, and to turn off the first local oscillator only when this is the case. As a result, a high reliability of the method is achieved also with a different tuning behavior of the local oscillators.

In regard to embodiments of the receiving device, the first frequency control element outputs a predefined base value, which after the turning on of the first local oscillator leads to a first fundamental frequency, which is further removed than the target frequency from the actual frequency of the particular local oscillator whose frequency has the smallest distance to the target frequency.

The receiving system can use a lower or upper end of a tuning range of the first frequency control element as the first base value.

The frequency control device can successively predefine at least one additional base value, which leads to another fundamental frequency that is closer to the target frequency than the first fundamental frequency.

The receiving system can turn off a mixer, which mixes a frequency of the first local oscillator with another frequency, during a change from the actual frequency to the target frequency.

In another embodiment, the receiving system has additional receivers, each of which has a local oscillator and a frequency control element, whereby the frequency control device outputs a first base value that is predefined such that it leads to a fundamental frequency that is above the actual frequencies of all local oscillators, which are smaller than the target frequency, and that is below the actual frequencies of all local oscillators, which are greater than the target frequency.

The frequency control device can be configured to store values that are assigned to the target frequency, the actual frequency of the first local oscillator, and the actual frequency of the second local oscillator, and to control the first frequency control element depending on the stored values such that it provides the first base value depending on the stored values.

The frequency control device can be hereby preferably configured to check, using the stored values, whether the actual frequency of the second local oscillator lies between the actual frequency of the first local oscillator and the target frequency, and to turn off the first local oscillator only when this is the case.

For these embodiments of the receiver, the advantages mentioned in the specifically corresponding embodiments of the method arise.

The first receiver can have a phase-locked loop coupled to the first local oscillator to regulate the frequency of the first local oscillator.

Phase-locked loops represent an option for a rapid and precise setting of the frequency of local oscillators.

In this case, it is preferable that the receiving system separates the phase-locked loop and sets a minimal or maximum value from a tuning range of the phase-locked loop as a control variable for the first local oscillator.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 illustrates a receiving system with n=2 receivers;

FIG. 2 illustrates a heterodyne frequency generator with the features of the invention;

FIG. 3 is time-correlated curves of different frequencies, amplitudes, and an activity state of the first local oscillator during a change in its frequency;

FIG. 4 is a curve of the frequency of the first local oscillator during a frequency change, with an unwanted overshoot;

FIG. 5 is a curve of the frequency of the first local oscillator during a frequency change, which was carried out with corrective measures to reduce the overshoot; and

FIG. 6 is an embodiment of the subject of FIG. 2, defined in terms of circuitry.

### DETAILED DESCRIPTION

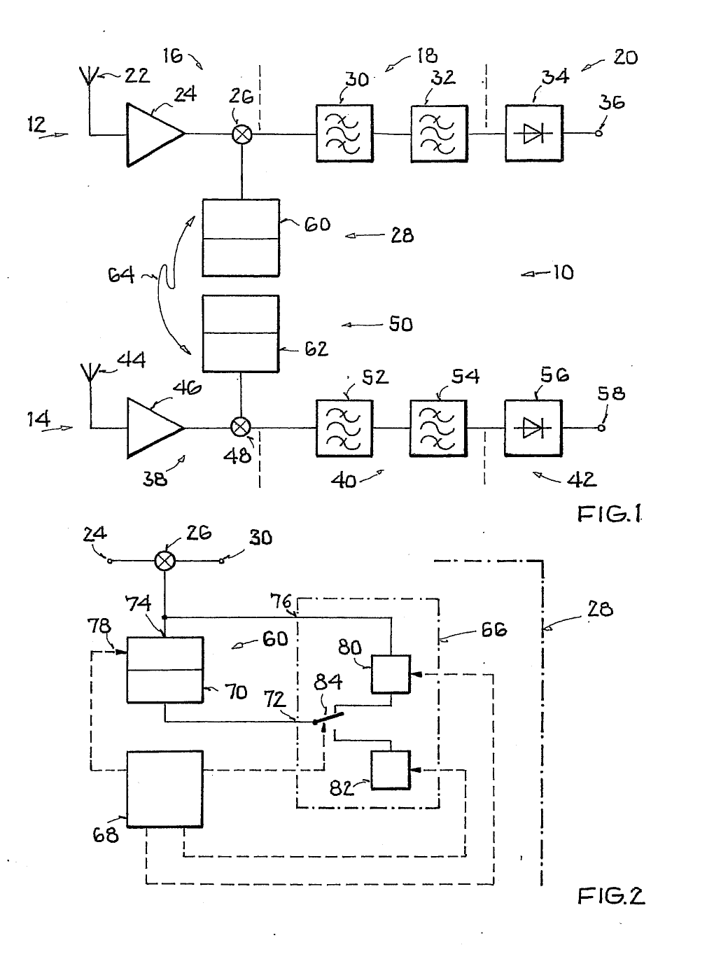

Specifically, FIG. 1 shows the entirety of a receiving system 10 having a first receiver 12 and a second receiver 14. First receiver 12 has a first high-frequency section 16, a first intermediate frequency section 18, and a first baseband or demodulation section 20. The design of the intermediate frequency section and the demodulation section is not relevant to the invention. The shown embodiments therefore serve only to depict the invention in a possible technical environment. The first high-frequency section 16 has a first antenna 22, by means of which the high-frequency signals or radio-frequency signals are fed to the first receiver 12. The fed signals are optionally amplified by a first low-noise amplifier 24, before they are down-mixed or shifted to an intermediate frequency in a first mixer 26 by mixing with a signal of a first heterodyne frequency generator 28. First intermediate frequency section 18, beginning with the output of first mixer 26, can have a first intermediate frequency filter 30, which, for example, can be realized as a bandpass filter with a bandwidth of 200 kHz. Furthermore, first intermediate frequency section 18 may have a first channel filter 32, which may have, for example, a bandwidth of 3.4 kHz and which is used for selecting the different transmission channels. The output signal of first channel filter 32 in this embodiment is demodulated in a first demodulator 34 and the demodulated signal is transmitted to a first connection point 36, which may be connected via additional amplifier and signal processing steps, for example, to a loudspeaker system. As already mentioned, the design of blocks 18, 20 is not relevant to the realization of the invention. In modern receivers, digitization is used, e.g., after the intermediate frequency filter. Further signal processing then takes place in a digital signal processor (DSP).

Similarly, second receiver 14 has a second high-frequency section 38, a second intermediate frequency section 40, a second baseband or demodulation section 42, a second antenna 44, a second low-noise amplifier 46, a second mixer 48, a second heterodyne frequency generator 50, a second intermediate frequency filter 52, a second channel filter 54, a second demodulator 56, and a second connection point 58. Here as well, the intermediate frequency filtering can occur alternatively in digitized form.

This type of structure corresponds to a receiving system known per se, as is used, for example, in an automobile radio with a so-called antenna diversity function.

Each heterodyne frequency generator 28, 50 has a local oscillator 60, 62, which can interfere in principle with the local oscillator of the specifically additional heterodyne frequency generator 28, 50 by electromagnetic coupling. This type of electromagnetic coupling is indicated by arrow 64 in FIG. 1.

FIG. 2 shows the details of an embodiment of first heterodyne frequency generator 28 having the features of the invention. First heterodyne frequency generator 28 has a first local oscillator 60 with a controllable output signal amplitude and a first frequency control element 66, which is controlled by an internal or external frequency control device 68, which also controls the output signal amplitude of oscillator 60. For this purpose, frequency control device 68 has, for example, a storage medium, in which a computer program is stored for use in a method not shown here, whereby the computer program is programmed for use in one of these methods.

The first local oscillator 60 has a tuning element 70, which is connected to an output 72 of first frequency control element 66 and with which the frequency of first local oscillator 60 can be tuned. First local oscillator 60 is connected via an output 74 to first mixer 26 and an input 76 of first frequency control element 66. Frequency dividers may be used optionally between the output of local oscillator 60 and mixer 26, or input 76. Via an input 78 of first local oscillator 60, its output signal amplitude is controlled by frequency control device 68, whereby the term control is intended to also cover the turning on and off of first local oscillator 60. First frequency control element 66 in an embodiment consists of a control value generator 80, a base value generator 82, and a switch 84, each of which are controlled by frequency control device 68.

Second heterodyne frequency generator 50 (see FIG. 1), which is not shown in FIG. 2, is preferably constructed analogously to first heterodyne frequency generator 28 and has a second local oscillator 62 (FIG. 1) with a second tuning element and a second frequency control element for tuning the frequency of second local oscillator 62.

Frequency control device 68 is connected both to first heterodyne frequency generator 28 and to second heterodyne frequency generator 50. In particular, frequency control device 68 is connected to first frequency control element 66 (or its components 80, 82, 84) and second frequency control element (or its corresponding components), to control the frequency control elements such that local oscillators 60, 62 generate one output signal each with the specifically desired frequency. Furthermore, frequency control device 68 for turning on and off the amplitude of the specific oscillator output signal is connected to the first and preferably to the second oscillator.

For the following description, F1 denotes an actual frequency of first local oscillator 60 and F2 an actual frequency of second local oscillator 62. Frequency control device 68 controls control value generator 80 and switch 84 of first frequency control element 66 such that first local oscillator 60 generates an output signal with actual frequency F1, whereas the control value generator of the second frequency control element is controlled such that second local oscillator 62 generates an output signal with actual frequency F2. Furthermore, F3 denotes a target frequency of the first local oscillator 60.

Preferably, the values of frequencies F1, F2, and F3 or values assigned to these frequency values (channel numbers, indexes, PLL divider values, etc.) are known to frequency control device 68 and are stored in a RAM memory of frequency control device 68. In order to carry out an interference-free frequency change of first local oscillator 60 from actual frequency F1 to target frequency F3, frequency control device 68 controls first frequency control element 66 preferably depending on these stored values. Because the stored values are assigned directly to the frequencies of the local oscillators, differences in the tuning behavior of the local oscillators do not have an advantageous effect due to the different frequency/control voltage characteristics.

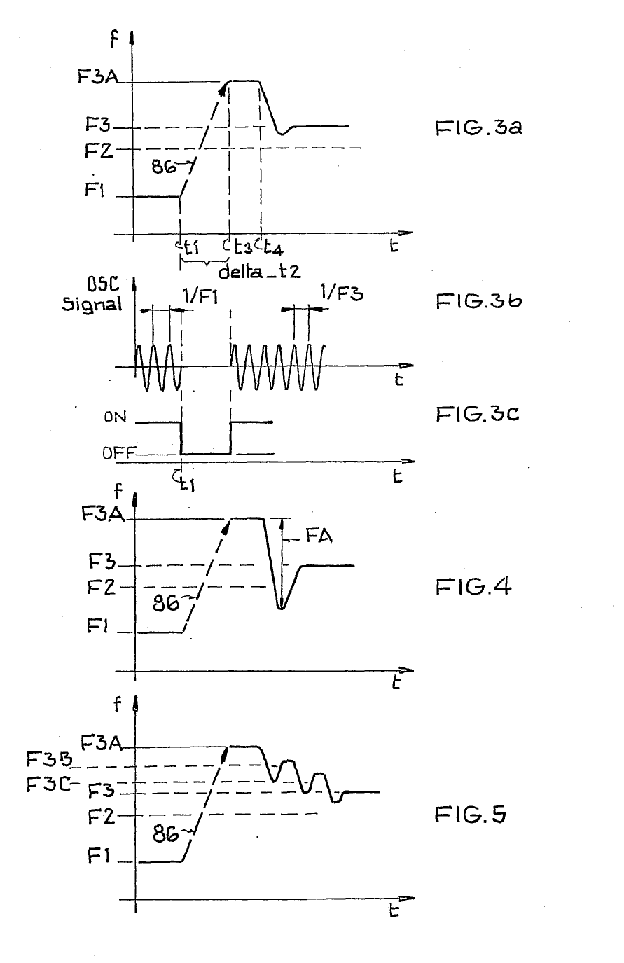

A first embodiment of a method for frequency change will be illustrated hereinafter with reference to FIG. 3 and FIGS. 1 and 2. In FIG. 3a, the frequency f of the output signal of first local oscillator 60 is shown versus time t. FIG. 3c illustrates an activity state changing between a turned on state “on” and a turned off state “off” of first local oscillator 60, and FIG. 3b illustrates qualitatively amplitudes and frequencies of its output signal during a frequency change.

Until time t1, first local oscillator 60 is turned on (compare FIG. 3c, “on”) and accordingly supplies a signal of frequency F1 and a predefined amplitude to first mixer 26 (compare FIG. 3b). The period duration of its output signal is thereby 1/F1. Frequency F1 is thereby stabilized by a closed loop from control value generator 80 of first frequency control element 66 and first local oscillator 60.

For the most interference-free change possible in the frequency of first local oscillator 60 from actual frequency F1, lying below frequency F2, to target frequency F3, lying above F2, first local oscillator 60 is turned off at time t1 (state “off” in FIG. 3c), so that its amplitude declines and in the extreme case disappears, which corresponds to the zero signal in FIG. 3b. This corresponds to a first step of the method.

With the eliminated amplitude of the output signal of first local oscillator 60, any potential interference emerging from this output signal is also eliminated. By the turning off/elimination of the amplitude, the frequency-stabilizing loop is separated action-wise.

Preferably, before the first step is performed, a check is made using the stored values whether actual frequency F2 of second local oscillator 62 in fact lies between actual frequency F1 of first local oscillator 60 and target frequency F3. Only when this condition is met in this case is first local oscillator 60 turned off and the steps described hereinafter performed. Because the stored values are directly assigned to the frequencies of the local oscillators, differences in the tuning behavior of the local oscillators advantageously have no effect on the method due to different frequency/control voltage characteristics so that a high reliability is then also achieved.

With a turned-off first oscillator 60, in a second step over a period delta_t2, the natural frequency of first local oscillator 60 is shifted by a control intervention in its tuning element 70 to target frequency F3 or an approximation value or base value F3A for setting of target frequency F3. In this case, the base value, dependent on the stored values, with appropriate setting of switch 84 is provided by base value generator 82. The shifting of the frequency of first local oscillator 60 is illustrated in FIG. 3a by dashed arrow 86. In this case, the (natural) frequency of first local oscillator 60 passes through frequency F2 of second local oscillator 62 with an amplitude, disappearing in the extreme case, so that no interfering coupling of first local oscillator 60 to second local oscillator 62 can occur.

Only after the (natural) frequency of first local oscillator 60 has passed through frequency F2 of second oscillator 62 is first oscillator 60 again turned on in a third step at time t3, whereby the amplitude of its output signal in the ideal case increases at the target frequency F3. The period duration of its output signals is then 1/F3. It must be observed here that the period of the oscillator signal is not drawn on the same time scale as the frequency changes. Typically, e.g., the transient from base value F3A to target frequency F3, therefore the frequency change after a time t4, lasts several milliseconds, but the oscillator period, however, is only 10 ns long, for example.

Because the frequency-stabilizing loop was separated by the turning off of first local oscillator 60 and by actuation of switch 84, first as a rule a frequency F3A, different from target frequency F3 and determined by the base value or control value, results after first local oscillator 60 is turned on again. To eliminate the deviation, in a fourth step, which is performed starting at a time t4, a shifting of the frequency target value of the frequency-stabilizing loop to the target frequency F3 occurs before the resetting of switch 84 in the switching state shown in FIG. 2. Because the resetting of switch 84 in conjunction with the restarting of first local oscillator 60 also again closes the frequency-stabilizing loop comprising first oscillator 60 and control value generator 80, the deviation is corrected, so that the output signal of first local oscillator 60 is set to desired target frequency F3. It is understood that the fourth step can occur before, after, and also parallel to the third step.

By this approach, first oscillator 60 is turned off at the time when its tuning element 70 is brought into a state in which first oscillator 60 would oscillate to frequency F2 of second oscillator 62 and would cause interferences in second receiver 14. As a result, interfering couplings 64 in second receiver 14 are avoided.

This method can be used in a development also for more than n=2 simultaneously operated receivers. In this case, tuning element 70 in the second step must be brought into a position that leads to an oscillation frequency F3A that is above the oscillation frequencies of all second local oscillators, operated at a frequency below target frequency F3, and that is below the oscillation frequencies of all second local oscillators, operated at a frequency above F3.

In both cases—two or more receivers—, despite the proposed method, it can result that first local oscillator 60 due to overshoot during activation of the frequency-stabilizing loop oscillates briefly in the vicinity of one of the frequencies F2 of the second local oscillators, as is illustrated by FIG. 4, for which in other respects the explanations for FIG. 3 apply. FIG. 4 shows in particular an overshoot with a frequency bandwidth FA, which extends from base value F3A beyond a frequency F2 of a second local oscillator 62. Because first local oscillator 60 during the building up of the frequency-stabilized loop oscillates again with a not negligible amplitude, the overshoot FA could lead to interfering couplings 64 in a second local oscillator 62 (see FIG. 1).

This potential problem can be avoided by first setting in the fourth step a frequency target value F3B of the frequency-stabilizing loop, which is sufficiently close to the base value F3A. As a result, the bandwidth FA of a possibly occurring overshoot is reduced and interfering interactions with other local oscillators in other receivers are avoided.

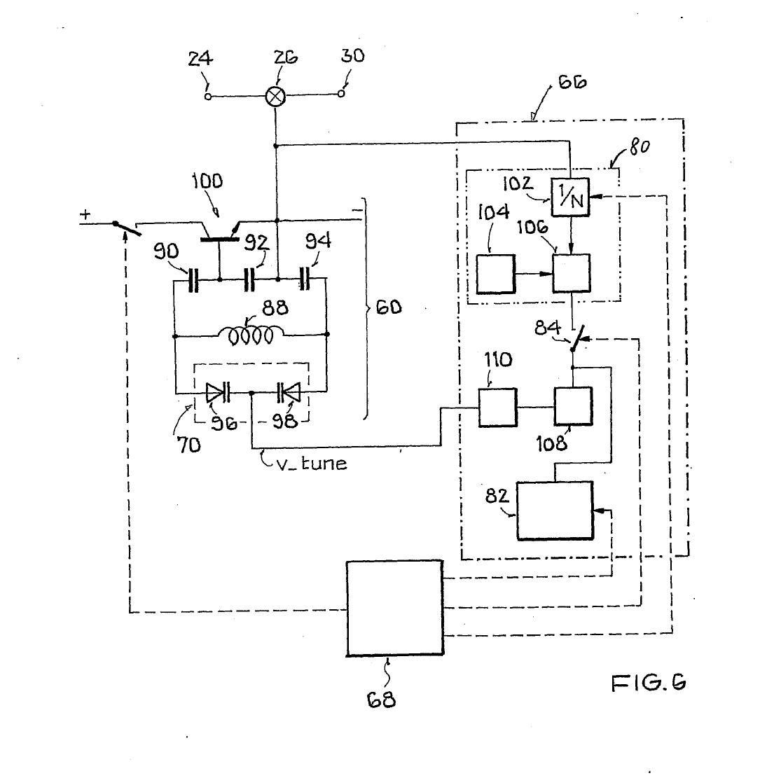

Then, the frequency target value of the frequency-stabilizing loop can be shifted optionally in several steps via intermediate values F3B, F3C to the target frequency F3, as a result of which a stepwise building up to the target frequency F3 results, without local oscillators in other receivers being affected. A transient of this type proceeding via intermediate values F3B, F3C is shown in FIG. 5.

This procedure presumes that the frequency bandwidth FA of the overshoot becomes smaller during activation of the frequency-stabilizing loop, or during the stepwise approach of its frequency target values to the target frequency F3, when the distance from base value F3A to an intermediate value F3B is selected as smaller than the distance of the base value F3A from target frequency F3. This is typically the case, for example, during use of a phase-locked loop as a frequency-stabilizing loop.

During the entire procedure for frequency change, the mixer can be turned off or the signal transmission from the heterodyne frequency generator to the mixer can be interrupted to avoid interferences in other system components by frequencies applied at the mixer during the frequency change. The frequency components at the mixer can differ from those of the local oscillator, e.g., during use of a frequency divider between the local oscillator and mixer.

The described method can also be used when two receivers are present in a system, which at times receive at the same frequency for an antenna diversity reception and this state is achieved by deactivating the associated local oscillator in a first receiver and using the oscillator signal of the other receiver. The first receiver can be tuned by the described method to another frequency without interfering with other receivers. The first step of the above-described method is superfluous in this case, because the oscillator of the first receiver is already turned off.

In the case of two receivers, for the tuning element (70) positions used in the second step of the above-described method, one position each above (or below) the setting range can be used, which is used for tuning to the frequencies in the receiving band.

The process control for the described tuning method can be realized, e.g., as software in a microcontroller, which has access to the corresponding components in the receiver via a control bus. Alternatively, a hardware realization in an integrated receiver circuit is also possible.

FIG. 6 shows the subject of FIG. 2 with further details of an embodiment of first frequency control element 66 with elements of a phase-locked loop of this type as control value generator 80, together with other details of an embodiment of first local oscillator 60. In this case, the same reference characters describe the same or functionally equivalent items.

First local oscillator 60 is realized, for example, as a voltage-controlled oscillator (VCO) with a parallel resonant circuit comprising inductive (88) and capacitive (90, 92, 94, 96, 98) AC resistors 88, 90 . . . , 98, whereby at least one capacitance diode or varactor diode 96, 98 serves as tuning element 70. The capacity of a capacitance diode 96, 98 of this type can be varied, as is known, by variation of a control direct voltage v_tune applied across it. Because the frequency of a resonant circuit of this type depends on the values of the involved inductive and capacitive AC resistors 88, 90, . . . , 98, a change in the control direct voltage v_tune is reproduced, as is known, in a predictable change in the resonant circuit frequency and thereby in a controllable change of the heterodyne frequency. The control direct voltage v_tune thereby represents a frequency control variable.

The resonant circuit is coupled, furthermore, with an energy supply, which can be turned on and off and which replaces in-phase the power loss radiated by the resonant circuit and Joule power loss and the power removed from the mixer. In the embodiment of FIG. 6, this is realized by transistor 100, which lies across a switch between the terminals “+” and “−” of a supply voltage and which is controlled by part of the alternating voltage arising across the resonant circuit. The switch for turning the energy supply on and off and thereby of first local oscillator 60 is controlled by frequency control device 68. According to the previous description of the method, frequency control device 68—preferably after checking the condition F1<F2<F3—controls the switch such that in step 1 it is opened and in step 3 of the method closed again, so that first local oscillator 60 is turned off between times t1 and t3, whereas it is otherwise turned on (see FIG. 3c).

In a realization of this type of first local oscillator 60, the tuning of the frequency of the resonant circuit is independent of the turning on/off of first local oscillator 60, therefore independent of the intervention in its oscillation amplitude. During the turning on/off of first local oscillator 60, the amplitude of its AC output signal changes, and during a change in the tuning voltage v_tune the frequency of its AC output signal. If first local oscillator 60 is turned on, an oscillation builds up with the frequency preset by tuning element 70 and the other elements of the resonant circuit. The amplitude increases during this turn-on process, but the frequency or period duration remains virtually constant.

The tuning voltage v_tune is provided by first frequency control element 66, which is controlled by frequency control device 68 depending on the stored values such that the frequency desired in each case results at the output of first local oscillator 60. To this end, control value generator 80 of the first frequency control element has a programmable frequency divider 102, a reference frequency generator 104, and a phase-frequency detector (PFD) 106. The frequency, output by first local oscillator 60, is divided down by frequency divider 102 and compared with a reference frequency, output by reference frequency generator 104. Depending on whether pulses of the divided oscillator signal lead or lag behind the pulses of the reference signal, phase frequency detector 106 controls a downstream charge pump 108 to output up-charging pulses or down-charging pulses, which charge or discharge a capacitor of a loop filter 110 and thereby stepwise change the control direct voltage v_tune provided by the loop filter.

In an alternative embodiment, a separate base value generator 82 can also be omitted. In this case, setting a base value for the target frequency directly by changing the factor N in the programmable frequency divider 102 could be considered. This is possible with difficulty, however, because no oscillator signal is applied at the input of the N divider, when the base value is set. Therefore, the base value is set preferably directly by the selective control of the current sources in charge pump 108. The tuning range of the phase-locked loop is then proportional to the difference in voltage, which arises across the loop filter capacitor in the case of full charging and full discharging by the current sources.

As shown in FIG. 6, programmable frequency divider 102, switch 84, and base value generator 82 are controlled by frequency control device 68, which controls these elements depending on the stored values, assigned to frequency values F1, F2, and F3, according to the previously described method such that first frequency control element 66 provides the first base value dependent on the stored values and possibly the additional base values, dependent on the stored values.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for changing a frequency of a first local oscillator in a receiving system which has a first receiver with the first local oscillator and a first frequency control element and a second receiver with a second local oscillator and a second frequency control element, the method comprising during a change in a frequency of the first local oscillator from an actual frequency of the first local oscillator to a target frequency at which an actual frequency of the second local oscillator lies between the actual frequency of the first local oscillator and the target frequency:
turning off the first local oscillator control of the first frequency control element such that the first frequency control element provides a first base value assigned to the target frequency of a frequency control variable;
turning on the first local oscillator; and
setting the frequency of the first local oscillator from a frequency determined by the base value to the target frequency.

2. The method according to claim 1 wherein the first base value is predefined such that after the turning on of the first local oscillator it leads to a first fundamental frequency that is above the actual frequency of the second local oscillator when the target frequency is above the actual frequency of the second local oscillator or that alternatively is below the actual frequency of the second local oscillator when the target frequency is below the actual frequency of the second local oscillator.

3. The method according to claim 1, wherein the first base value is predefined such that after the turning on of the first local oscillator it leads to a first fundamental frequency that is further removed from the actual frequency of the second local oscillator than the target frequency.

4. The method according to claim 1, wherein the setting step has a successively occurring presetting of at least one additional base value, which leads to another fundamental frequency closer to the target frequency than the first fundamental frequency.

5. The method according to claim 1, wherein additional frequencies, susceptible to interference, are taken into account in selecting the first fundamental frequency.

6. The method according to claim 4, wherein in a receiving system with additional receivers, each of which has a local oscillator and a frequency control element, the first base value is predefined such that it leads to a fundamental frequency that is above the actual frequencies of all local oscillators, which are smaller than the target frequency, and that is below the actual frequencies of all local oscillators, which are greater than the target frequency.

7. The method according to claim 1, further comprising a step of storing of values assigned to the target frequency, the actual frequency of the first local oscillator (60), and the actual frequency of the second local oscillator, wherein the first frequency control element, depending on the stored values, is controlled such that it provides the first base value depending on the stored values.

8. The method according to claim 7, wherein based on the stored values a check is performed whether the actual frequency of the second local oscillator lies between the actual frequency of the first local oscillator and the target frequency, and wherein the first local oscillator is turned off only when this is the case.

9. A receiving system comprising:
a first receiver with a first local oscillator and a first frequency control element;
at least one second receiver with a second local oscillator and a second frequency control element; and
a frequency control device, which controls and/or regulates a change in a frequency of the first local oscillator from an actual frequency of the first local oscillator to a target frequency,
wherein an actual frequency of the second local oscillator lies between the actual frequency of the first local oscillator and the target frequency,
wherein the frequency control device turns off the first local oscillator, controls the first frequency control element such that the first frequency control element provides a first base value assigned to the target frequency of a frequency control variable, and turns on the first local oscillator, and
wherein the first frequency control element sets the frequency of the first local oscillator from a frequency determined by the base value to the target frequency.

10. The receiving system according to claim 9, wherein the first frequency control element outputs a predefined base value, which after the turning on of the first local oscillator leads to a first fundamental frequency, which is further removed than the target frequency from the actual frequency f the particular local oscillator whose frequency has the smallest distance to the target frequency.

11. The receiving system according to claim 9, wherein the system uses a lower or upper end of a tuning range of the first frequency control element as the first base value.

12. The receiving system according to claim 9, wherein the first frequency control element successively predefines at least one additional base value, which leads to another fundamental frequency that is closer to the target frequency than the first fundamental frequency.

13. The receiving system according to claim 9, wherein said system turns off a mixer, which mixes a frequency of the first local oscillator with another frequency, during a change from the actual frequency to the target frequency.

14. The receiving system according to claim 9, wherein said system has additional receivers, each of which has a local oscillator and a frequency control element, whereby the first frequency control device outputs a first base value which is predefined such that it leads to a fundamental frequency that is above the actual frequencies of all local oscillators, which are smaller than the target frequency, and that is below the actual frequencies of all local oscillators, which are greater than the target frequency.

15. The receiving system according to 9, wherein the first receiver has a phase-locked loop coupled to the first local oscillator to regulate the frequency of the first local oscillator.

16. The receiving system according to claim 15, wherein said system separates the phase-locked loop and sets a minimal or maximum value from a tuning range of the phase-locked loop as a control variable for the first local oscillator.

17. The receiving system according claim 9, wherein the frequency control device is configured to store values assigned to the target frequency, the actual frequency of the first local oscillator, and the actual frequency of the second local oscillator, and to control the first frequency control element depending on the stored values such that it provides the first base value depending on the stored values.

18. The receiving system according to claim 17, wherein the frequency control device is configured to check, based on the stored values, whether the actual frequency of the second local oscillator lies between the actual frequency of the first local oscillator and the target frequency, and to turn off the first local oscillator only when this is the case.

19. The receiving system according to claim 9, wherein the frequency control device is programmed for use in the method according to claim 1.

20. A computer program, wherein it is programmed for use in the method according to claim 1.

21. A storage medium of a frequency control device of a receiving system, wherein a computer program for use in the method of claim 1 is stored in the storage medium.
